(19) United States
(12) Patent Application Publication
(10) Pub. No.: US 2008/0013228 A1
(43) Pub. Date: Jan. 17, 2008

(54) Reversible Optical Shutter Driver

(76) Inventor: Ronald S. Conero, San Diego, CA (US)

Correspondence Address: WILLIAM J. KOLEGRAFF;KESTREL WIRELESS, INC., 15050 AVENUE OF SCIENCE, STE. 230, SAN DIEGO, CA, 92128, US

(21) Appl. No.: 11/778,259

(22) Filed: Jul. 16, 2007

Related U.S. Application Data
(60) Provisional application No. 60/807,387, filed on Jul. 14, 2006.

(51) Int. Cl. H02H 9/08

(52) U.S. Cl. 361/43

(57) ABSTRACT

A circuit for managing current for a reversible thin film stack is provided. The circuit is able to block or substantially restrict leakage current from the film stack when the circuit is in a power-off state. The circuit, in one arrangement, is also able to provide a more steady flow of charge into the film stack, thereby facilitating fast transition, while maintaining sufficient power to other parts of the system. In one arrangement, the circuit is in the form of an integrated circuit, and is positioned in or on an optical disc. The circuit connects to a thin-film optical shutter, which may be set in a clear state that allows the disc to be played, or set in dark state that makes the disc unplayable. The circuit reduces leakage current, allowing the optical shutter to maintain the desired state.

### RELATED APPLICATIONS

This application claims priority to U.S. patent application No. 60/807,387, filed Jul. 14, 2006, and entitled, “Reduced Leakage EC Film Driver”, which is incorporated herein by reference.

### FIELD

The present invention relates to a circuit and process for providing power to a thin film stack and limiting the stack's leakage current. The circuit may be integrated into an integrated circuit device or constructed of discrete components, and may responds to control functions provided by a processor.

### BACKGROUND

A thin film stack, such as an electrochromic (EC) film, changes color states by the application of a voltage potential across its electrodes. The voltage causes a charge transfer to occur, which changes the optical properties of the film. By reversing the potential across the film, it can be switched to the opposite optical state. Once the film has accepted sufficient charge to change states, the drive voltage can be removed and the film will remain in that state, as long as no leakage current paths exist to discharge the film to its rest state. In some cases, a very low leakage may be acceptable, according to the application requirements. Discharge currents cause the accumulated charge across the film to dissipate, and the film changes its optical properties in an undesirable way. Shorting the film for instance will cause the film to seek an intermediate rest state between each of the fully charged states, either positive, or negative. This state cannot be allowed for some applications of EC Films.

Difficulty arises, for example, when an electronic circuit in integrated chip form is interfaced to the EC Film. Not only must the circuit drive the film in a bipolar mode when the chip is powered by an external RF field, it must not allow any currents (or only extremely small currents) to flow when the chip if powered off. The EC Film will be in one of the two charged states. Either positive, or negative. In these states, the EC Film acts somewhat like a battery and has voltage present across the EC Film. This voltage will be present across the output terminals of the chip which drives it, even after the chip is powered off. Current chip technologies which utilize silicon as the semiconductor material to implement the chip circuitry, have substrate diodes present between the input and output pins of the chip, and the supply pins, typically labeled Vcc and Vss. In some cases the diodes exist as a result of how the circuit is fabricated on the silicon, and in other cases the diodes are purposely included as a way of making the chip tolerant of static discharge events to the input/output pins, which could damage the chip.

These substrate diodes are normally reversed biased when the chip is powered by an external supply. The supply could be a battery, a DC supply powered by the AC line, or RF power. Under this condition, the substrate diodes are reversed biased and do not represent leakage current paths for the EC Film. However, this condition changes when the chip loses RF power, or voltage between Vcc and Vss. In this condition, the substrate diodes appear as back to back diodes between each I/O pin and Vss. If the film is connected between any I/O pin and Vss, or between 2 I/O pins, it effectively has a discharge path thru the substrate diode, which is now forward biased. This causes a current to flow in the EC Film, which changes its optical state.

### SUMMARY

Briefly, the present invention provides a circuit for managing current for a reversible thin film stack. The circuit is able to block or substantially restrict leakage current from the film stack when the circuit is in a power-off state. The circuit, in one arrangement, is also able to provide a more steady flow of charge into the film stack, thereby facilitating fast transition, while maintaining sufficient power to other parts of the system. In one arrangement, the circuit is in the form of an integrated circuit, and is positioned in or on an optical disc. The circuit connects to a thin-film optical shutter, which may be set in a clear state that allows the disc to be played, or set in dark state that makes the disc unplayable. The circuit reduces leakage current, allowing the optical shutter to maintain the desired state.

### BREIF DESCRIPTION OF THE DRAWINGS

FIG. 1 is an illustration of an optical disc having a reversible optical shutter with reduced leakage current, with the optical shutter in the dark state.

FIG. 2 is an illustration of an optical disc having a reversible optical shutter with reduced leakage current, with the optical shutter in the clear or bleached state.

FIG. 3 is a block diagram of a circuit for providing reduced leakage current.

FIG. 4 is the circuit of FIG. 3 shown transitioning the optical shutter.

FIG. 5 is a block diagram of a circuit for providing reduced leakage current.

FIG. 6 is the circuit of FIG. 5 shown transitioning the optical shutter to the clear or bleached state.

FIG. 7 is the circuit of FIG. 5 shown transitioning the optical shutter to the dark state.

### DETAILED DESCRIPTION

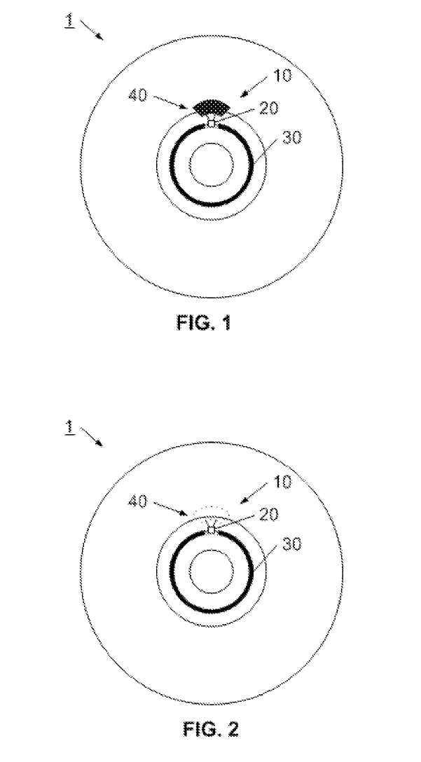

Referring now to FIGS. 1 and 2, an optical disc 1 is illustrated. Optical disc 1 may be, for example, a DVD, a Blu-ray disc, an HD-DVD, a music CD, a data CD, or a game CD. The optical disc 1 has an optical shutter 40. The optical shutter 40 is typically a reversible thin-film stack that has a dark state (FIG. 1) or a bleached or clear state (FIG. 2). The materials, processes, and uses of a such a thin-film stack are fully described in copending U.S. patent application Ser. No. 11/460,827, filed Jul. 28, 2006, and entitled, “Persistent Electro-Optic Devices and Processes for Optical Media”, which is incorporated herein in its entirety. The optical shutter is reversible, that is, it can transition between its states under control of the processor 20. The shutter has an electro-optic or electro-chromic material that in a clear or bleached state allows the disc to be played in an associated disc player, and in the dark state, disrupts the player's ability to read the disc.

Processor 20 connects to an antenna 30 for receiving an RF signal. The RF signal may be a UHF signal or an HF signal. It will be understood that the particular antenna design will be according to the RF band being used. The processor 20 also has a radio transceiver for receiving and sending data to an associated reader or scanner, and also has power convertor circuitry for converting the RF signal to power. In this way, the RF signal received from the reader/scanner is able to power-up the processor 20, and the processor 20 and the reader/scanner are able to communicated data and instructions. Processor 20 also has output lines connected to the optical shutter 40. In this way, the processor 20 is able to send a power signal to the optical shutter to effect a state transition. Typically, sending power with one polarity arrangement will transition in one direction, while sending power in the other polarity arrangement will transition in the other direction. The construction and use of RF circuits for controlling an optical shutter is fully described in U.S. patent application Ser. No. 11/457,428, filed Jul. 13, 2006, and entitled, “Devices and Methods for RF Communication with an Optical Disc”, which is incorporated herein in its entirety.

Optical disc 1 may be manufactured and initially shipped with the optical shutter 40 in its dark state. Since the disc will not play in a typical disc player, the disc is less likely to be stolen, and may be packaged, shipped, and displayed with reduced security measures. At a point of sale, a reader/scanner provides an RF signal that powers-up processor 20. Processor 20 and the reader/scanner communicate data packages to authenticate the disc 1 and to confirm that the disc is ready for activation. If the disc is ready, then the reader/scanner sends an activation key to the processor 20. If the key is correct, then the processor 20 applies power to the optical shutter. The power is applied with the polarity set to transition the optical shutter from the dark state to the clear state.

At a later time, the consumer may return the disc to the retailer. To accept the disc back into stock, the retailer uses another reader/scanner device to power-up and communicate with the disc. However, this time the reader/scanner provides the instructions for the processor to provide the power at the polarity to cause the optical shutter 40 to transition back to the dark state. Then, the disc may be returned to stock. It will be appreciated that many applications may benefit from a reversible thin film stack.

The processor 20 has circuitry to more stably maintain the optical shutter in its desired state. Since a reversible thin-film stack has a potential, this circuitry acts to block or substantially restrict the amount of current that can leak when the processor is not powered.

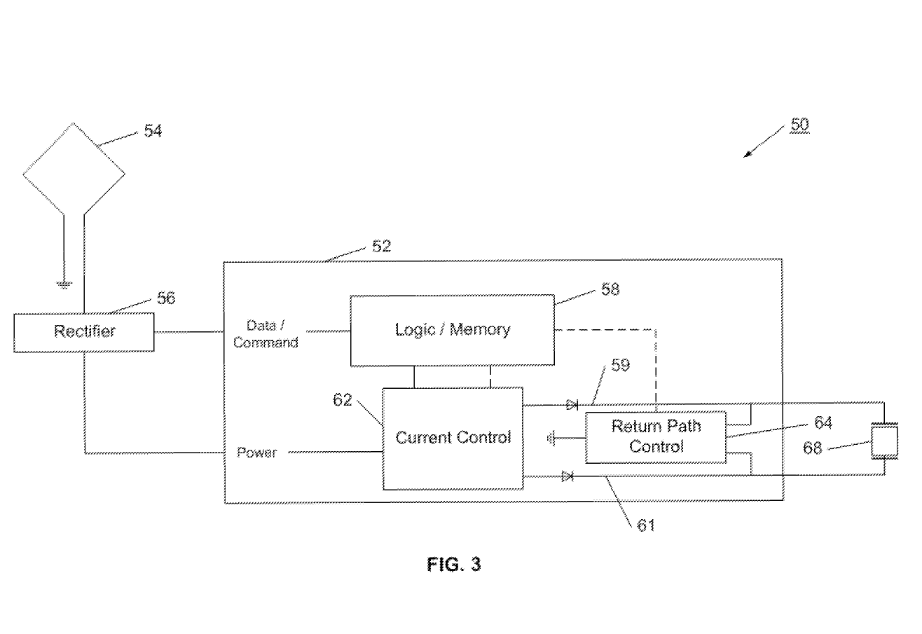

Referring now to FIG. 3, a reduced-leakage current circuit is illustrated. Circuit 50 has a processor 52 connected to an antenna 54. When in the presence of a proper RF field, a rectifier provides the processor 52 with a power signal, and allows the processor and a scanner/reader to communicate data. The data is used by logic and memory 58 to determine when it is appropriate to transition the thin-film stack 68 to its other state. The circuitry 50 has a current control module 62 that determines which of two current lines 59 or 61 is used. Each current line 59 and 60 requires a different isolated return path, which is selected by the return path control 64. To transition in one direction, the processor 52 selects line 59 and its associated isolated return path. To transition in the other direction, the processor selects line 61 and its associated isolated return path. Also, current control 62 may act to control the amount of current flowing into the film stack. When power is first applied to the film-stack, the amount of charge transferred to the film stack is limited through a relatively large resistive load. By limiting the amount of power drawn by the film stack, the risk of deactivating the processor is reduced. As the film stack charges, the resistive load is reduced, but current stays relatively constant to the film stack. By keeping the current to the film stack relatively constant, the film can be transitioned rapidly, and the risk of killing the processor is reduced. It will be apperceived that the current regulation may be done in an open loop arrangement, or may be adjusted responsive to the measured level of current moving into the film stack. Also, although the current regulation may be implemented using resistive or other loads, it will be appreciated that current can be limited or adjusted in other ways.

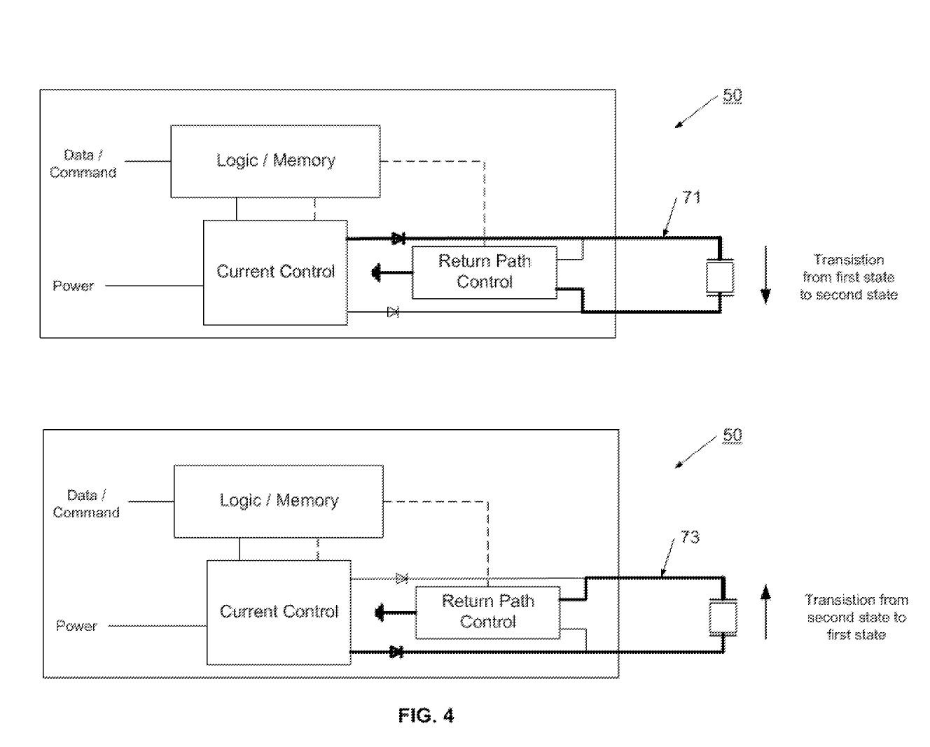

FIG. 4 shows the circuit 50 of FIG. 3 transitioning from a first state to a second state. In this transition, the processor uses the current control module and the return control module to set current path 71. Even when power is removed from the processor, the selected return path continues to act block or substantially limit leakage current when the thin film is in its second state. FIG. 4 also shows the circuit 50 of FIG. 3 transitioning from the second state to the first state. In this transition, the processor uses the current control module and the return control module to set current path 73. Even when power is removed from the processor, the selected return path continues to act block or substantially limit leakage current when the thin film is in its first state.

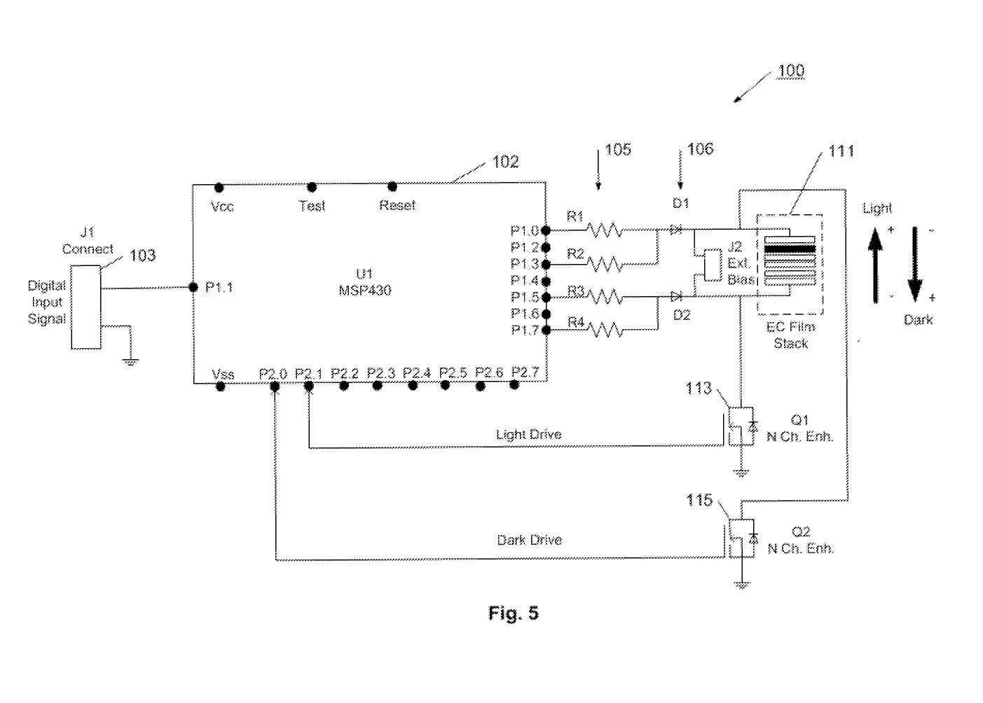

Referring now to FIGS. 5, 6, and 7, a specific implementation of a reduced-leakage circuit 100 is illustrated. Although a specific example is shown, it will be understood that any integrated circuit device may be isolated by this technique, and that the circuit could be integrated into an integrated circuit chip.

The example circuit (100) as shown in FIG. 5 is implemented as a discrete-component design. It will be understood that the implementation of FIG. 5 may be modified in many ways consistent with this disclosure, and that it is readily adaptable to integration into an integrated circuit chip. Referring to FIG. 5, U1 (102) is a microcontroller (uC) from TI, a MSP430. Other processors may be used. It is powered from an external power source (not shown). The power source applies a positive voltage to the Vcc terminal with respect to the Vss terminal. This voltage is typically +3.6 Volts, but will depend on specific components selected. The microcontroller 102 receives input data signals via port P1.1 from an external source, which instructs the microcontroller to change its I/O port pins (P1.0 to P1.7, and P2.0 to P2.7) in accordance with its internal coded instructions. Note that in alternate implementations the instructions may be hard coded into the chip as a hardware state machine, as opposed to firmware instructions residing in internal memory. The ports of the microcontroller which are used, (P2.0, P2.1, P1.0, P1.3, P1.5, and P1.7) are configured as digital outputs. They switch levels between Vss and Vcc. Substrate diodes exist on each of these port lines to Vcc and Vss within the uC.

A current limiting module 105 acts to linearize the charge passed to the EC film stack 111. R1 thru R4 (105) serve to limit the current that the film can draw from the output ports during switching. The EC Films behave similar to both batteries and capacitors in that they work by a transfer of charge. If the film is switched by a constant voltage source, it draws a very high initial current which then decreases in approximately exponential fashion to zero. This is similar to hanging an uncharged capacitor across the output port of the IC. The resulting large current would cause the voltage supply of the IC to collapse since there is a very limited amount of RF power available to power the IC. Therefore, it is desirable to limit the current draw, and R1 thru R4 (105) provide this function. However, if a single resistor is used to limit the current, the charge transfer takes about 3 time constants (3RC), where R is the limiting resistor, and C is the capacitance of the EC Film. This is undesirable, so two different value resistors are connected to 2 ports, so that either or both of them can limit the current. By properly switching the outputs, the current draw of the film can be maintained at relatively constant value. This allows the time constant for switching to be reduced, while still limiting the current to an allowable level that can be supply via the RF source. It will be understood that more or fewer resisters may be used to provide the current curve needed for a particular application.

Diodes D1 and D2 (106) provide isolation from the substrate diodes in the microcontroller 102. Q1 (113) and Q2 (115) are N channel enhancement mode FETS which allow the EC Film 111 to be driven in a bipolar fashion. As will be further described, these FETS act as isolation switches. The substrate diodes in the FET's (113 and 115) provide another isolation barrier for leakage currents from the EC film stack 111.

J2 (107) may be a physical connector, or simply pads on the optical media, chip, or EC film 111 that allows an external DC supply to bias the EC Film in either of two states, based on the connection polarity. This can be achieved with the microcontroller in an un-powered condition. This may be very desirable during the manufacturing process in order to initialize the EC film in its dark state.

As an example, if the microcontroller is not powered, all of its I/O ports are at zero volts, and further, are in a high impedance condition. However, the substrate diodes are effectively connected back to back between each I/O port and Vss. Since the ports are at zero volts, Q1 (113) and Q2 (115), which are enhancement mode FET's, are turned off. If a battery is connected across J2 (107) in such a way that the one terminal is driven positive with respect to the other terminal of the EC film stack, then the film will be charged to its dark state. Note that there is no current path for positive current to flow from the film stack. Diode D2 (106), and the substrate diode of Q1 (113) are both reversed biased, and Q1 (113) is off. When the battery is removed, this situation remains the same. Without any current path, the EC film 111 retains its charge. In reality, there will be some very small leakage current thru D1 (106), the substrate diodes in the microcontroller, and the substrate diode of Q1 (113). Since this is a series path, the magnitude of the current can be controlled by selecting D2 (106) to be very low leakage. If the polarity of the battery across J2 (107) is reversed, the EC film 111 is charged to the alternate state (Light). Since the circuit is symmetric, the same analysis applies. D1 (106), and the substrate diode of Q2 (115) are reversed biased, and Q2 (115) is off, so no current flow can occur.

Note that the EC film 111 will not be discharged by the un-powered circuit in either state. Further, it does not matter if the film was charged by an external battery, or the circuit itself, when powered.

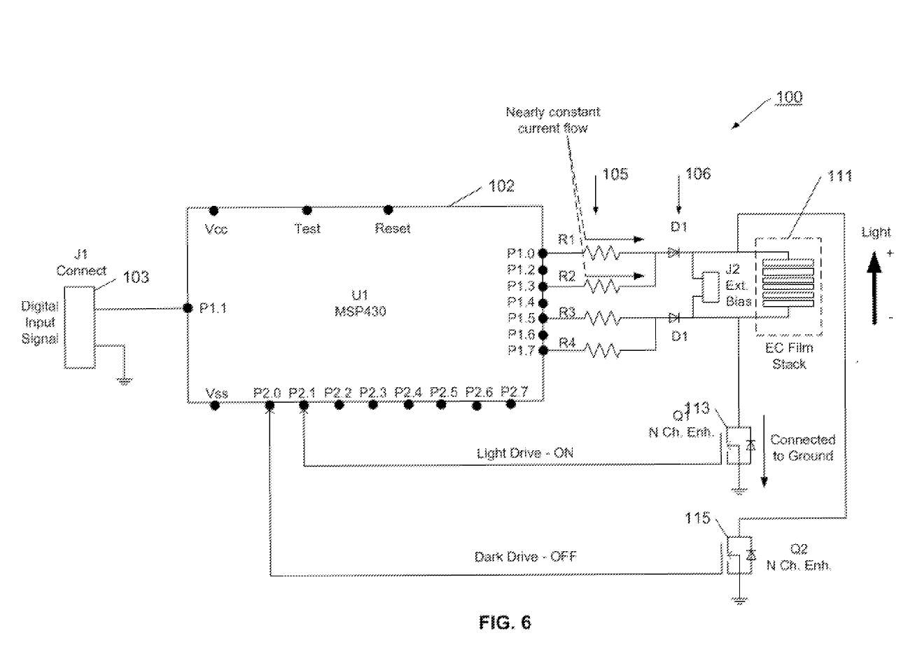

The circuit can change the state of the EC film stack from its initial dark state to the Light state, in the following manner (see FIG. 6). The uC powers up from an external RF power source, and receives a command to activate the optical media by switching the EC Film state to Light. The uC asserts P2.1 which causes the LIGHTDRIVE signal to go high, which turns on Q1 (113). At the same time, P1.0 is asserted and goes high. This in turn causes a current to flow thru R1 and deliver charge to the EC film 111. As the EC film 111 accepts the charge, its terminal voltage increases, which reduces the voltage drop across R1. In order to keep the current relatively constant, P1.3 is asserted high, and P1.0 is asserted low. This increases the current by about a factor of 2. At some later time, P1.0 is asserted high again, and the current is now increased once again, since R1 and R2 are effectively in parallel. This keeps the current approximately constant and allows the EC film 111 to charge approximately 3 times faster than using a single resistor to limit the current. Once the EC film is charged, P1.0 and P1.3 can remain high until the uC powers down, or P1.0 and P1.3 can be asserted low, along with P2.1.

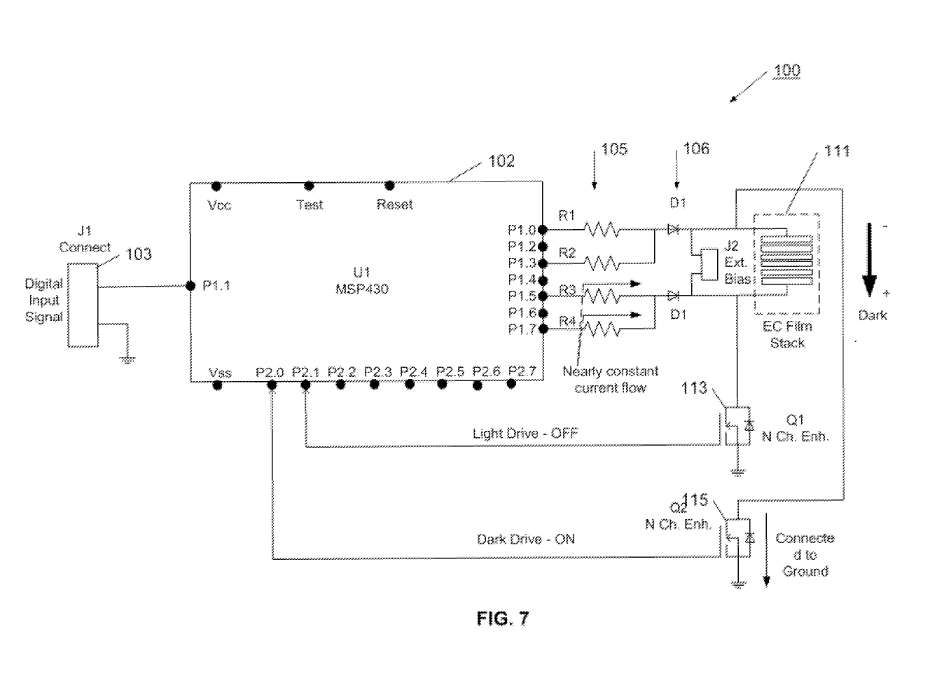

The EC Film can also be switched by the circuit to the dark state for the Light state by asserting P2.0, P1.5, and P1.7 while all the other ports are low (see FIG. 7). Asserting P2.0 and P2.1 both high is not allowed, as that would turn on both Q1 and Q2 and effectively short the EC Film to zero volts, which is not a desired optical state.

A truth table for the system is shown in Table 1 below.

TABLE 1
System States

| Chip | | | | | | | Film |
|---|---|---|---|---|---|---|---|
| State | P1.0 | P1.3 | P2.1 | P1.5 | P1.7 | P2.0 | State |
| No | 0 | 0 | 0 | 0 | 0 | 0 | Either - |
| Pwr | | | | | | | Hold |
| Pwr | 1 | 0 | 1 | 0 | 0 | 0 | >Light |
| Pwr | 0 | 1 | 1 | 0 | 0 | 0 | >Light |
| Pwr | 1 | 1 | 1 | 0 | 0 | 0 | LIGHT |
| Pwr | 0 | 0 | 0 | 0 | 0 | 0 | LIGHT |
| Pwr | 0 | 0 | 0 | 1 | 0 | 1 | >Dark |
| Pwr | 0 | 0 | 0 | 0 | 1 | 1 | >Dark |
| Pwr | 0 | 0 | 0 | 1 | 1 | 1 | DARK |
| Pwr | 0 | 0 | 0 | 0 | 0 | 0 | DARK |
| Pwr | x | x | 1 | x | x | 1 | Shorts |
| | | | | | | | the Stack |

In some cases it may be desirable to discharge the thin film stack. For example, if the film stack is charged in one state, the film stack can quickly, and without the application of power, transition to its rest state. If both P2.0 and P2.1 are turned on, then both Q1 (113) and Q2 (115) are activated. In this way the terminals of the film stack are shorted to ground, and the film stack quickly discharges to its rest state. After the stack is in its rest state, then the circuit 100 can resume operation as discussed above to set the film into its desired state. By first shorting the film, the overall transition may be completed more quickly and with less power. In some cases, the rest state may be one of the desired states. In this case, if the film stack is in the other state, then simply shorting the film stack as described will transition the stack.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A circuit for reducing leakage current, comprising:
a reversible electro-optic film stack having a positive terminal and a negative terminal;
a first current line having a diode arranged to allow current to pass to the positive terminal;
a second current line having a diode arranged to allow current to pass to the negative terminal;
a first isolation switch that connects the negative terminal to ground when the first current line is active; and
a second isolation switch that connects the positive terminal to ground when the first current line is active.

2. The circuit according to claim 1, wherein the diodes and isolation switches are constructed in an integrated circuit.

3. The circuit according to claim 1, wherein the diodes and isolation switches are discreet components external to an integrated circuit.

4. The circuit according to claim 1, wherein the first current line further comprises an adjustable load.

5. The circuit according to claim 1, wherein the first current line further comprises a plurality of selectable resistors.

6. The circuit according to claim 1, wherein the isolation switches are FETs.

7. The circuit according to claim 1, wherein the reversible electro-optic film stack is integrated into an optical disc.

8. The circuit according to claim 1, wherein the reversible electro-optic film stack is on an optical disc.

9. The circuit according to claim 1, further comprising:
the first isolation switch is capable of connecting the negative terminal to ground when the first current line is not active;
the second isolation switch is capable of connecting the positive terminal to ground when the second current line is not active; and
wherein the reversible electro-optic film stack is shorted when both the first and second isolation switches are connected to ground.

10. An integrated circuit, comprising:
a first and a second power connection to a reversible film stack; and
a current control module that selects one of the power connections as an output port and connects the other power port to an isolated ground.

11. The integrated circuit according to claim 10, wherein the current control module further comprises an adjustable load.

12. The integrated circuit according to claim 10, wherein the current control module further comprises a plurality of selectable resistors.

13. The integrated circuit according to claim 10, wherein the current control includes a measurement circuit arranged to measure current flowing to the reversible film stack.

14. The integrated circuit according to claim 10, further including a return control module that selectively connects the power ports to an isolated ground.

15. The integrated circuit according to claim 14, wherein the power ports are controllable to short the connections to the reversible film stack.

16. The integrated circuit according to claim 14, further including isolation switches for connecting the power ports to an isolated ground.

17. The integrated circuit according to claim 16, wherein the isolation switches are FETs.
